(19) United States
(12) Patent Application Publication
(10) Pub. No.: US 2018/0141053 A1
(43) Pub. Date: May 24, 2018

(54) ORE BENEFICIATION PROCESS

(71) Applicant: SIGNET AGGREGATES, LLC, Casper, WY (US)

(72) Inventor: ROBERT DELANE BALDWIN, Casper, WY (US)

(73) Assignee: SIGNET AGGREGATES, LLC, Casper, WY (US)

(21) Appl. No.: 15/355,931

(22) Filed: Nov. 18, 2016

(51) Int. Cl. B02C 19/06; B03C 1/30; B02C 23/10; B02C 23/14

(52) U.S. Cl. CPC B02C 19/066; B03C 1/30; B03C 2201/18; B02C 23/14; B02C 23/10

(57) ABSTRACT

An apparatus and process for beneficiating ores in an economic and environmentally friendly manner can often beneficiate ores, often from less than 20% concentration, to over 70%, an increase of over 50%, or a 250% increase. The apparatus and process use positive displacement fluid pumps and a high impact collision in a stationary impact chamber. The ore and embedding, or waste, material is pumped as a slurry through a ½-inch to 4-inch nozzle, for example, to collide with a stationary plate in an impact chamber at high velocities. The impact partially disassociates these materials. The post impact slurry exiting the impact chamber may be usable as-is, or may be further treated, as desired, by secondary component material separation methods, such as gravity, magnetic, mechanical or the like.

### BACKGROUND OF THE INVENTION

### 1. Field of the Invention

One or more embodiments of the invention relates generally to ore mining processes. More particularly, the invention relates to an ore beneficiation process that can raise concentrations of desirable ores in a sample, such as those previously considered waste material, to commercially useful ores while minimizing tailing pilings.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Increasingly, ore is discovered and mined at less than useable concentrations, and ores must be beneficiated prior to smelting or other use. In the mining industry, beneficiation is any process that improves the economic value of the ore by removing the gangue minerals, which results in a higher grade product and a waste stream, often referred to as tailings. Iron, aluminum and gold, among other ores, must be concentrated prior to use.

Chemical and thermal methods currently considered state of the art and in widespread use globally, are expensive and many cause unwanted environmentally hazardous byproducts with minimal beneficiation. The energy necessary to break the bonds between the ores and the surrounding materials, when delivered through chemical or thermal media, are energy inefficient and often have byproducts that create environmental issues.

Conventional beneficiation processes include gravity separation, magnetic separation, chemical separation, thermal separation and mechanical separation. Gravity separation involves the use of jigs, spirals and tables to separate ores and to concentrate the desired ore. These processes are variations of sorting processes and do not employ high energy impact to improve ore concentrations. Increased concentrations of roughly 4% are common with these methods. Magnetic separation has been used commonly and is limited by the concentration of the ore in each particle. Chemical separation methods, such as flotation or dissolution of cementing materials between the desired ore and the contaminant or embedding material exist as well. In thermal separation, the bond between the ore and surrounding material can be weakened or broken through roasting or other thermal means. This method is energy intensive with varying effectiveness. Finally, in mechanical separation, grinding is used to shrink overall particle size prior to some form of gravity, magnetic or chemical separation.

Currently, materials with ore concentrations less than market minimums are considered a waste product, but could be returned to industry use with a more efficient beneficiation method.

In view of the foregoing, there is a need for improvements in ore beneficiation processes that can increase desirable ore concentrations in ore materials, many of which may have been previously considered as waste products.

### SUMMARY OF THE INVENTION

Embodiments of the present invention provide an ore beneficiation apparatus comprising a slurry tank; a slurry pump receiving an ore slurry from the slurry tank; an impact chamber having an impact plate on at least one end thereof; a nozzle receiving slurry from the pump and directing the slurry toward the impact plate; and a mesh screen to separate ore bodies of post impact discharge.

Embodiments of the present invention further provide a method for beneficiating ore comprising delivering an ore slurry to contact an impact plate; collecting a post impact slurry discharge from the ore slurry after impacting the impact plate; and separating a beneficiated ore from the post impact slurry discharge.

Embodiments of the present invention also provide a method for beneficiating ore comprising pumping an aqueous ore slurry from a slurry tank to a pump outlet tube; delivering the ore slurry, via a nozzle at the end of the pump outlet tube, to contact an impact plate within an impact chamber; collecting a post impact slurry discharge from the ore slurry after impacting the impact plate; and separating a beneficiated ore from the post impact slurry discharge.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 is a schematic representation of an ore beneficiation apparatus according to an exemplary embodiment of the present invention; and

FIG. 2 is a flow chart describing a process using the beneficiation apparatus of FIG. 1, according to an exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

A description of an embodiment with several components in communication with each other does not imply that all such components are required. On the contrary, a variety of optional components are described to illustrate the wide variety of possible embodiments of the present invention.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide an apparatus and process for beneficiating ores in an economic and environmentally friendly manner. The process and apparatus of the present invention can often beneficiate ores, often from less than 20% concentration, to over 70%, an increase of over 50%, or a 250% increase. The apparatus and process mechanically beneficiates ore by use of positive displacement fluid pumps and high impact collision in a stationary impact chamber. The ore and embedding, or waste, material is pumped as a slurry through a ½-inch to 4-inch nozzle, for example, to collide with a stationary plate in an impact chamber at high velocities. The impact partially disassociates these materials. The post impact slurry exiting the impact chamber may be further treated, as desired, by secondary component material separation methods, such as gravity, magnetic, mechanical or the like. Conventional beneficiating methods fail to make substantial increases, such as increases of greater than 20%, in ore concentrations. Moreover, the conventional methods often result in environmentally damaging byproducts and are cost limiting or prohibitive.

The increase in beneficiation through aqueous mechanical means is novel and unexpected. Impact separation through preferential particle breakage due to differential brittleness of component materials, or the supercharging or porous materials, destabilizing them in contrast to less porous metals, was not directly apparent. While not being limited to any specific theory of operation, the present invention provides improved beneficiation over conventional methods.

The apparatus and process of the present invention can take input materials, with inadequate ore concentrations, and replace these with commercially usable concentrations of a variety of ores. Embodiments of the present invention can reduce the alkali concentrations of specific iron ore input materials to improved levels for commercial use in cement manufacturing. Embodiments of the present invention can separate and concentrate, or beneficiate, multiple ore components in one process, such as iron, aluminum and gold all beneficiating from one input material. In some embodiments, silica concentrations of output material can approach commercial silica levels in silica rich ore input materials. Mine waste materials, or tailing piles, are reduced by the processes of the present invention.

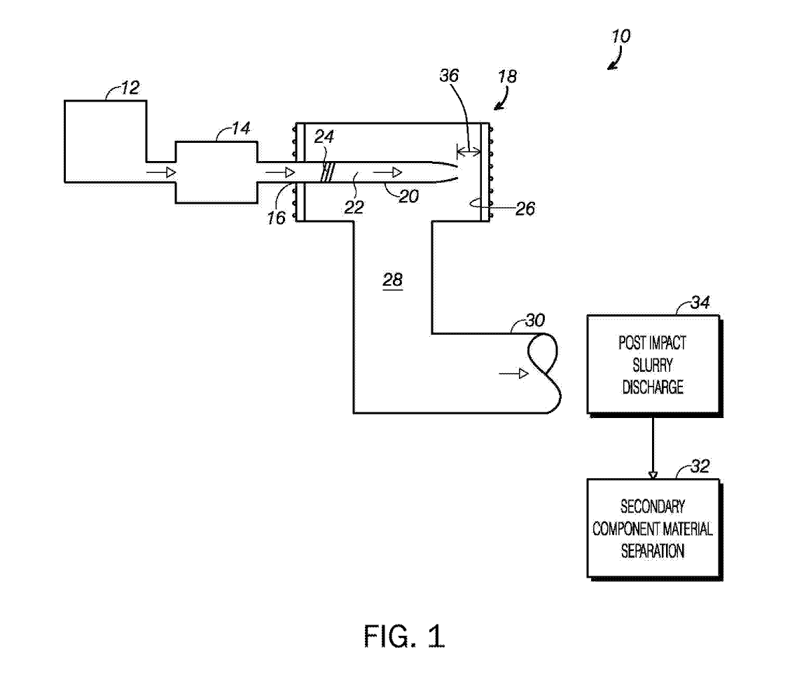

Referring now to FIG. 1, a beneficiation apparatus 10 can receive a slurry mix of ore into a slurry tank 12. This slurry mix may be pumped, via one or more slurry pumps 14 into an impact chamber 18 and can exit, via a nozzle 20 to strike an impact plate 26. The impacted slurry 34 may exit through an opening 28 in the bottom of the impact chamber 18 and a channel 28 may be located beneath the opening 28 to allow the resulting impacted slurry 34, also referred to as post impact slurry discharge 34, to flow to a secondary separation phase 32, which can include, for example, gravity, chemical or magnetic separation. The specifics of the secondary separation phase 32 may be based on both the ore sought and the embedding, or host, materials. Thermal or further mechanical means of separation may also be utilized at the secondary separation phase 32.

The nozzle 20 may have a threaded region 22 that may mate with a threaded region 24 on the output tube 16 from the slurry pump 14. Threaded region 22 may be, for example, a female threaded region and threaded region 24 may be a male threaded region, however, the threads may be reversed within the scope of the present invention. The threaded regions 22, 24 allow the user to easily change the nozzle 20 to a desired diameter and distance 36 away from the impact plate 26, depending on the input ore, the desired output ore, input slurry rate, liquid concentration in the slurry, pump rate, and the like.

In some embodiments, the nozzle 20 may be formed from a 2-inch pipe that narrows to 1.5 inches at its end. The impact chamber 18 may be formed from a 6-inch pipe with the impact plate 26 disposed at a closed end thereof. The end of the nozzle 20 may be disposed a distance 36 from about 1 inch to about 6 inches, typically from about 2 inches to about 4 inches, from the impact plate 26. Of course, the sizes of each component (such as the nozzle 20 and the impact chamber 18) and the distance between the nozzle 20 and the impact plate 26 may vary depending on the particular application.

The process, according to embodiments of the present invention, may be used with varying input slurry rates and nozzle sizes to optimize the material separation and subsequent ore beneficiation. Temperature variations could increase component material brittleness differentiation. The stationary impact place and impact chamber could be optimized per input material such as by modifying the impact angle, impact plate design or distance of the impact plate from the nozzle.

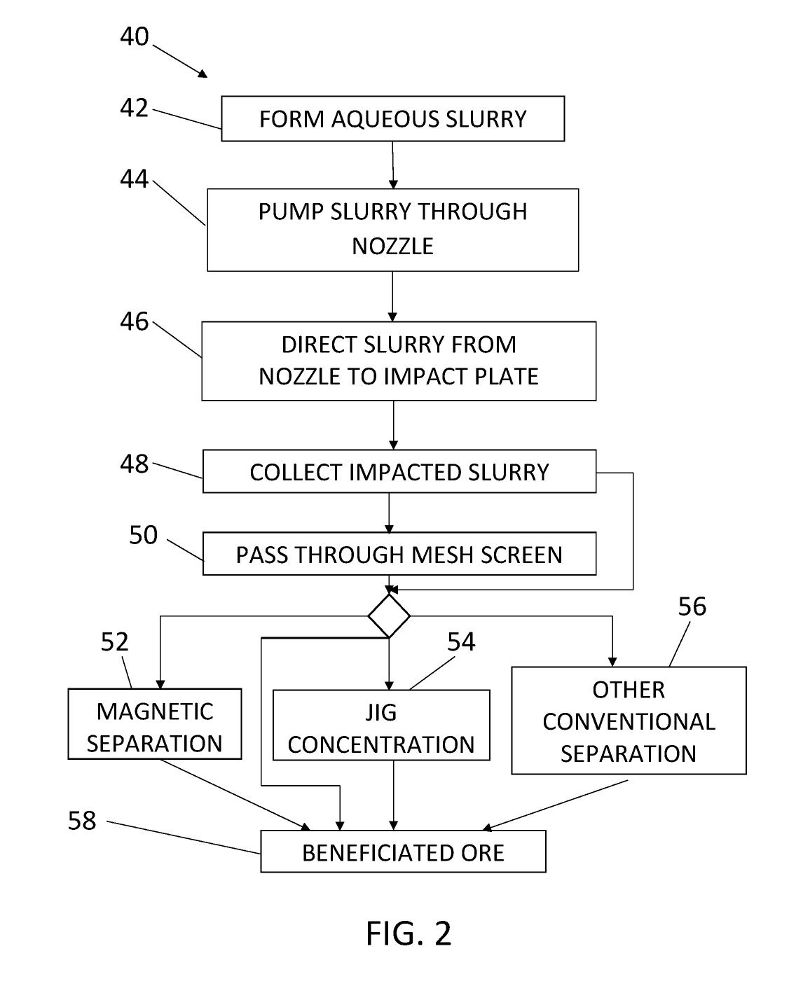

Referring to FIG. 2, a process 40 according to an exemplary embodiment of the present invention is outlined. The process 40 includes a step 42 of forming an aqueous slurry of the raw ore to be processed. The aqueous slurry may be formed in various concentrations/thicknesses, depending the specific application. The process 40 includes a step 44 of pumping the aqueous slurry through a nozzle with a pump. The pump, such as slurry pump 14, may be a fluid displacement pump, for example. The process 40 further includes a step of directing the pumped slurry, through a nozzle, to an impact plate, such as impact plate 26. The pumped slurry may collide with the impact plate at a fluid velocity of, for example, about 40-180 feet per second. The slurry is then collected in step 48 and various secondary treatments, such as particle size separation/passing through a mesh screen 50, magnetic separation 52 and jig concentration 54 may be used. The resulting beneficiated ore may be collected and used at step 58. As shown in FIG. 2, the step 50 of passing through a mesh screen may be optional, as well as one or more of the step 52 (magnetic separation), step 54 (jig concentration) and step 56 (other conventional separation).

Secondary component material separation, after the high energy aqueous impact against the impact plate, can vary by input material between mechanical, gravity, magnetic and, while not used in the examples below, chemical processes. Variation in control and measurement of each item described above can modify the process improvement and optimization. Chemicals modifying the contact angle of the aqueous solution may alter porous material saturation and thereby embedding material breakage. Specific chemicals may enhance dissolution or weakening of cementing material within the embedding material or between it and the metal.

### EXAMPLES

A first sample ore, designated ore SP, had a SiO₂ concentration of 62.82% and an Fe₂O₃ concentration of 14.94%. The concentrations of other components of ore SP are shown in Table 1 below.

The ore SP was treated by various conventional methods, where ore C1 was material picked up by a low grade magnet and C2 was material not picked up by a low grade magnet. C3 was material crushed to 40-mesh and the sample picked up with a magnet was tested. C4 was washed over Miner's Moss and the material trapped in the moss was exposed to a magnet. The C4 sample is that picked up by the magnet. The C5 sample was washed over Miner's Moss, run through a jig concentrator, and exposed to a magnet, where the material picked up by the magnet was tested.

The ore SP was treated by various methods within the scope of the present invention. Samples E1 through E18 on the table below were passed through the beneficiation apparatus 10 of the present invention, where the ore SP was formed into an aqueous slurry and impacted against an impact plate. The resulting impacted slurry was passed through various mesh screens, where samples E1 through E6 were sized at 12-20 mesh, samples E7 through E12 were sized at 20-30 mesh, and samples E13-E18 were sized at a minimum of 30 mesh. For each particle size, samples were taken from various locations of a weight separation table, where the first three samples for each sample size (E1 through E3, E7 through E9 and E13 through E15) are of the heaviest weight product on the table and the last three samples for each sample size (E4 through E6, E10 through E12 and E16 through E18) are of the lightest weight product on the table.

Sample 19 was passed through the apparatus of the present invention (similar to samples E1 through E18 above) and was then treated with a jig concentrator and then magnet exposure. The sample retained by the magnet was analyzed. Sample E20 was the same as E19, but without the magnet exposure.

TABLE 1
Ore SP with conventional treatments and treatments according to the present invention

| Ore | P₂O₅ | SiO₂ | Fe₂O₃ | Al₂O₃ | TiO₂ | MnO₂ | CaO | MgO | K₂O | Na₂O | SO₃ | BaO | SrO |
|---|---|---|---|---|---|---|---|---|---|---|---|---|---|
| SP | 0.11 | 62.82 | 14.9 | 6.89 | 0.54 | 0.20 | 5.00 | 3.80 | 0.60 | 0.86 | 0.27 | 0.02 | 0.01 |
| C1 | 0.14 | 68.07 | 15.15 | 5.13 | 0.40 | 0.18 | 4.25 | 3.22 | 0.46 | 0.69 | 0.43 | 0.03 | 0.02 |
| C2 | 0.14 | 57.64 | 14.64 | 9.40 | 0.79 | 0.23 | 6.11 | 4.65 | 0.80 | 1.22 | 0.31 | 0.03 | 0.02 |
| C3 | 0.09 | 67.13 | 15.32 | 6.91 | 0.54 | 0.20 | 4.95 | 3.71 | 0.64 | 0.90 | 0.08 | 0.02 | 0.01 |
| C4 | 0.09 | 63.56 | 20.82 | 6.50 | 0.54 | 0.21 | 5.04 | 3.79 | 0.58 | 0.78 | 0.27 | 0.02 | 0.01 |
| C5 | 0.16 | 74.63 | 22.60 | 1.15 | 0.12 | 0.09 | 1.78 | 1.29 | 0.16 | 0.15 | 0.23 | 0.01 | 0.01 |
| E1 | 0.10 | 60.09 | 23.49 | 6.26 | 0.55 | 0.22 | 5.32 | 3.73 | 0.50 | 0.79 | 0.54 | 0.02 | 0.01 |
| E2 | 0.01 | 66.12 | 14.79 | 6.53 | 0.54 | 0.20 | 5.34 | 3.74 | 0.52 | 0.87 | 0.39 | 0.02 | 0.01 |
| E3 | 0.03 | 67.03 | 14.89 | 6.20 | 0.50 | 0.19 | 5.24 | 0.36 | 0.51 | 0.84 | 0.33 | 0.02 | 0.01 |
| E4 | 0.04 | 71.12 | 13.96 | 5.90 | 0.48 | 0.18 | 4.98 | 3.31 | 0.49 | 0.82 | 0.28 | 0.02 | 0.01 |
| E5 | 0.08 | 71.67 | 11.94 | 5.80 | 0.45 | 0.17 | 4.78 | 3.14 | 0.49 | 0.84 | 0.26 | 0.02 | 0.01 |
| E6 | 0.03 | 76.96 | 9.32 | 4.84 | 0.35 | 0.14 | 4.11 | 2.49 | 0.45 | 0.79 | 0.27 | 0.02 | 0.01 |
| E7 | 0.46 | 39.24 | 49.99 | 4.39 | 0.57 | 0.22 | 3.71 | 2.72 | 0.33 | 0.46 | 0.03 | 0.02 | 0.01 |
| E8 | 0.13 | 55.18 | 25.68 | 5.73 | 0.59 | 0.21 | 5.00 | 3.42 | 0.43 | 0.70 | 0.57 | 0.02 | 0.01 |
| E9 | 0.11 | 63.50 | 17.70 | 6.23 | 0.55 | 0.21 | 5.25 | 3.51 | 0.50 | 0.81 | 0.35 | 0.02 | 0.01 |
| E10 | 0.14 | 67.86 | 15.22 | 5.63 | 0.46 | 0.18 | 4.92 | 3.18 | 0.48 | 0.76 | 0.34 | 0.02 | 0.01 |
| E11 | 0.09 | 71.85 | 14.01 | 5.58 | 0.45 | 0.18 | 4.95 | 3.16 | 0.46 | 0.77 | 0.28 | 0.02 | 0.01 |
| E12 | 0.03 | 76.96 | 10.17 | 4.77 | 0.31 | 0.16 | 4.65 | 2.62 | 0.49 | 0.76 | 0.28 | 0.02 | 0.01 |
| E13 | 0.32 | 56.48 | 22.86 | 4.48 | 1.77 | 0.24 | 4.12 | 2.47 | 0.43 | 0.61 | 0.44 | 0.03 | 0.01 |
| E14 | 0.24 | 26.02 | 67.39 | 2.85 | 0.62 | 0.23 | 2.31 | 1.68 | 0.26 | 0.20 | 0.43 | 0.04 | 0.00 |
| E15 | 0.18 | 38.71 | 51.98 | 3.76 | 0.55 | 0.24 | 3.40 | 2.20 | 0.30 | 0.27 | 0.78 | 0.03 | 0.01 |
| E16 | 0.11 | 67.62 | 15.02 | 5.56 | 0.49 | 0.19 | 5.26 | 3.25 | 0.53 | 0.68 | 0.36 | 0.02 | 0.01 |
| E17 | 0.06 | 74.81 | 12.40 | 5.19 | 0.39 | 0.17 | 4.71 | 2.93 | 0.54 | 0.69 | 0.28 | 0.02 | 0.01 |
| E18 | 0.02 | 78.60 | 10.04 | 4.65 | 0.30 | 0.15 | 4.37 | 2.56 | 0.52 | 0.66 | 0.38 | 0.02 | 0.01 |
| E19 | 0.26 | 22.23 | 70.96 | 1.51 | 1.22 | 0.42 | 2.28 | 1.32 | 0.22 | 0.10 | 0.89 | 0.12 | 0.00 |
| E20 | 0.13 | 55.30 | 26.92 | 4.46 | 0.55 | 0.22 | 4.15 | 2.53 | 0.38 | 0.55 | 0.41 | 0.06 | 0.01 |

In the above Table 1, any difference from the total components of an ore sample and 100% is considered “undetermined” for these studies. All values are weight percent.

As can be seen from the above Table 1, conventional processes, including magnetic separation, crushing, use of miner's moss, and the use of a jig separator resulted in minimal beneficiation of iron oxide. At best, treatment with miner's moss, a jig separator and magnetic separation resulted in an increase in iron oxide concentration from 14.94% to 22.60%.

On the contrary, the methods of the present invention results in significantly improved iron oxide beneficiation. For example, E14 is one of the heavy samples from the weight separation table which shows a beneficiation of iron oxide from 14.94% to 67.39%. If a jig concentrator is used in conjunction with the apparatus of the present invention described above, along with magnetic separation, an iron oxide beneficiation from 14.94% to 70.96% was achieved. It should be noted that the above results do not include any energy inefficient thermal processes or any environmentally unfriendly chemical treatments.

Table 2, below, a different ore sample, ore SR, had a SiO2 concentration of 34.35% and an Fe2O3 concentration of 43.73%. The concentrations of other components of ore SR are shown in Table 2.

The ore SR was treated by various methods within the scope of the present invention. Samples E21 through E26 on the table below were passed through the beneficiation apparatus 10 of the present invention, where the ore SR was formed into an aqueous slurry and impacted against an impact plate. The resulting impacted slurry was treated as noted below. Sample E21 was treated with a jig concentrator and magnetic separation. Samples E22 through E24 were treated with a jig concentrator and gravity table where the material was sized 12-20 mesh (E22), 20-30 mesh (E23) and 30 mesh minimum (E24) for testing. Sample E25 was treated with a jig concentrator and sample E26 is the material rejected from the jig concentrator.

TABLE 2
Ore SR after treatments according to the present invention

| Ore | P₂O₅ | SiO₂ | Fe₂O₃ | Al₂O₃ | TiO₂ | MnO₂ | CaO | MgO | K₂O | Na₂O | SO₃ | BaO | SrO |
|---|---|---|---|---|---|---|---|---|---|---|---|---|---|
| SR | 0.72 | 34.35 | 43.73 | 14.22 | 0.20 | 0.10 | 2.57 | 0.84 | 4.92 | 0.00 | 0.00 | 0.03 | 0.11 |
| E21 | 0.73 | 20.78 | 70.24 | 7.68 | 0.47 | 0.26 | 1.70 | 0.83 | 2.18 | 0.07 | 0.00 | 0.10 | 0.06 |
| E22 | 0.28 | 3.52 | 92.45 | 3.48 | 0.21 | 0.17 | 0.67 | 0.30 | 0.80 | 0.00 | 0.00 | 0.15 | 0.04 |
| E23 | 0.36 | 0.00 | 87.96 | 2.82 | 1.73 | 0.21 | 0.42 | 0.29 | 0.68 | 0.00 | 0.00 | 0.12 | 0.04 |
| E24 | 0.48 | 2.61 | 83.47 | 3.91 | 1.44 | 0.18 | 0.69 | 0.35 | 1.12 | 0.00 | 0.00 | 0.08 | 0.04 |
| E25 | 1.30 | 17.24 | 73.65 | 7.34 | 0.21 | 0.10 | 1.34 | 0.46 | 2.28 | 0.00 | 0.00 | 0.05 | 0.07 |
| E26 | 0.93 | 45.15 | 26.02 | 16.91 | 0.24 | 0.11 | 2.60 | 1.02 | 5.88 | 0.03 | 0.00 | 0.03 | 0.12 |

In the above Table 2, any difference from the total components of an ore sample and 100% is considered “undetermined” for these studies. All values are weight percent.

As can be seen, the methods of the present invention can increase the ore SR from 43.73% to over 92% without thermal or chemical treatments.

Of course, the above examples are merely exemplary embodiments of the present invention and various secondary separation processes may or may not be used, in various combinations, with the beneficiation apparatus 10 described above.

The processes of the present invention may be performed in various manners, including in batches or continuously, depending on the treatment steps and particular application.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. An ore beneficiation apparatus comprising:
a slurry tank;
a slurry pump receiving an ore slurry from the slurry tank;
an impact chamber having an impact plate on at least one end thereof;
a nozzle receiving slurry from the pump and directing the slurry toward the impact plate; and
a chamber to receive the post impact slurry discharge.

2. The ore beneficiation apparatus of claim 1, wherein the nozzle removably attached to an output pipe from the slurry pump.

3. The ore beneficiation apparatus of claim 1, wherein the nozzle is from about 1 inch to about 6 inches from the impact plate.

4. The ore beneficiation apparatus of claim 1, wherein the nozzle if from about ½ inch to about 4 inches in diameter.

5. The ore beneficiation apparatus of claim 1, further comprising a secondary component material separation unit receiving the post impact slurry discharge from the chamber.

6. A method for beneficiating ore comprising:
delivering an ore slurry to contact an impact plate;
collecting a post impact slurry discharge from the ore slurry after impacting the impact plate; and
separating a beneficiated ore from the post impact slurry discharge.

7. The method of claim 6, wherein the ore slurry is an aqueous slurry.

8. The method of claim 6, pumping the ore slurry from a slurry tank to a nozzle, where the nozzle points at the impact plate.

9. The method of claim 7, wherein the pump is a fluid discharge pump.

10. The method of claim 8, further comprising threading the nozzle on an output of the pump.

11. The method of claim 6, further comprising performing a secondary component material separation on the post impact slurry discharge.

12. The method of claim 12, wherein the step of performing a secondary component material separation on the post impact slurry discharge includes separating the post impact slurry discharge by particle size.

13. The method of claim 12, wherein the step of performing a secondary component material separation on the post impact slurry discharge includes magnetically separating the post impact slurry discharge.

14. The method of claim 12, wherein the step of performing a secondary component material separation on the post impact slurry discharge includes jig concentrating the post impact slurry discharge.

15. A method for beneficiating ore comprising:
pumping an aqueous ore slurry from a slurry tank to a pump outlet tube;
delivering the ore slurry, via a nozzle at the end of the pump outlet tube, to contact an impact plate within an impact chamber;
collecting a post impact slurry discharge from the ore slurry after impacting the impact plate; and
separating a beneficiated ore from the post impact slurry discharge.

16. The method of claim 15, further comprising threading the nozzle on an output of the pump.

17. The method of claim 15, further comprising performing a secondary component material separation on the post impact slurry discharge.

18. The method of claim 17, wherein the step of performing a secondary component material separation on the post impact slurry discharge includes separating the post impact slurry discharge by particle size.

19. The method of claim 17, wherein the step of performing a secondary component material separation on the post impact slurry discharge includes magnetically separating the post impact slurry discharge.

20. The method of claim 17, wherein the step of performing a secondary component material separation on the post impact slurry discharge includes jig concentrating the post impact slurry discharge.
